(19) United States
(12) Patent Application Publication
(10) Pub. No.: US 2013/0050280 A1
(43) Pub. Date: Feb. 28, 2013

(54) DISPLAY SYSTEM, CONTROL CIRCUIT FOR GENERATING A BACKLIGHT DRIVING CURRENT AND METHOD THEREOF

(71) Applicant: Yi-Jui Huang, Taoyuan County (TW)

(72) Inventor: Yi-Jui Huang, Taoyuan County (TW)

(21) Appl. No.: 13/239,405

(22) Filed: Sep. 22, 2011

(30) Foreign Application Priority Data
Aug. 22, 2011 (TW) 100130005

(51) Int. Cl. G09G 5/10

(52) U.S. Cl. 345/690

(57) ABSTRACT

A control circuit for generating a backlight driving current includes a timing control circuit, a resistor, and a backlight driving circuit. The timing control circuit is used for receiving a first pulse width modulation (PWM) dimming signal and an image signal, and converting the first PWM dimming signal to a second PWM dimming signal according to the image signal. A duty cycle of the first PWM dimming signal is proportional to a duty cycle of the second PWM dimming signal. The backlight driving circuit is coupled to the timing control circuit and the resistor for receiving the second PWM dimming signal and generating the backlight driving current according to the second PWM dimming signal and the resistor.

### BACKGROUND OF THE INVENTION

1. Field of the Invention

The present invention is related to a display system, a control circuit for generating a backlight driving current and method thereof, and particularly to a display system, a control circuit and method thereof that can utilize a timing control circuit to generate different pulse width modulation signals according to corresponding image signals for a backlight driving circuit to generate corresponding backlight driving currents.

2. Description of the Prior Art

Please refer to FIG. 1 and FIG. 2. FIG. 1 is a diagram illustrating a control circuit 100 for generating two-dimensional (2D)/three-dimensional (3D) backlight driving currents according to the prior art, and FIG. 2 is a diagram illustrating a control circuit 200 for generating 2D/3D backlight driving currents according to the prior art. As shown in FIG. 1, the control circuit 100 includes a timing control circuit 102, a backlight driving circuit 104, a switch 106, and two resistors R1, R2. The timing control circuit 102 is used for receiving an image signal IS, and generating a pulse width modulation signal PWM to the backlight driving circuit 104, and a 2D/3D signal to the switch 106 according to the image signal IS. When the image signal IS is a 3D image signal, the 2D/3D signal is at a logic-high voltage, so that the switch 106 is turned on. The backlight driving circuit 104 can generate greater a backlight driving current ISET (a 3D backlight driving current) according to the resistor R1 (a smaller resistance). Similarly, when the image signal IS is a 2D image signal, the 2D/3D signal is at a logic-low voltage, so that the switch 106 is turned off. The backlight driving circuit 104 can generate a smaller backlight driving current ISET (a 2D backlight driving current) according to a series resistance of the resistor R1 and the resistor R2 (a greater resistance).

As shown in FIG. 2, the control circuit 200 includes a timing control circuit 202, a backlight driving circuit 204, two switches 206, 208, and two resistors R1, R2. When an image signal IS is a 3D image signal, a 2D/3D signal is at the logic-high voltage, so that the switch 206 is turned on and the switch 208 is turned off. The backlight driving circuit 204 can generate a greater backlight driving current ISET (a 3D backlight driving current) according to the resistor R1 (a smaller resistance). Similarly, when the image signal IS is a 2D image signal, the 2D/3D signal is at the logic-low voltage, so that the switch 206 is turned off and the switch 208 is turned on. The backlight driving circuit 204 can generate a smaller backlight driving current ISET (a 2D backlight driving current) according to the resistor R2 (a greater resistance).

Although the control circuit 100 and the control circuit 200 can adjust the backlight driving current ISET (the 2D backlight driving current or the 3D backlight driving current) according to the image signal IS, the control circuit 100 and control circuit 200 require many additional passive devices and increase layout windings, resulting in cost and production complexity being increased.

### SUMMARY OF THE INVENTION

An embodiment provides a control circuit for generating a backlight driving current. The control circuit includes a timing control circuit, a resistor, and a backlight driving circuit. The timing control circuit is used for receiving a first PWM dimming signal and a image signal, and converting the first PWM dimming signal to a second PWM dimming signal according to the image signal, where a duty cycle of the second PWM dimming signal is proportional to a duty cycle of the first PWM dimming signal. The backlight driving circuit is coupled to the timing control circuit and the resistor for receiving the second PWM dimming signal and generating a backlight driving current according to the second PWM dimming signal and the resistor.

Another embodiment provides a display system. The display system includes a display panel, a timing control circuit, a resistor, and a backlight driving circuit. The timing control circuit is used for receiving a first PWM dimming signal and an image signal, and converting the first PWM dimming signal to a second PWM dimming signal according to the image signal, where a duty cycle of the second PWM dimming signal is proportional to a duty cycle of the first PWM dimming signal. The backlight driving circuit is coupled to the timing control circuit and the resistor for receiving the second PWM dimming signal and generating a backlight driving current according to the second PWM dimming signal and the resistor. The backlight driving current is used for driving a light emitting diode (LED) backlight module of the display panel.

Another embodiment provides a method for generating a backlight driving current. The method includes receiving a first PWM dimming signal and an image signal; converting the first PWM dimming signal to a second PWM dimming signal according to the image signal; and generating a first backlight driving current according to the second PWM dimming signal and a resistor coupled to a backlight driving circuit.

The present invention provides a display system, a control circuit for generating a backlight driving current and method thereof. The display system, the control circuit and the method utilize a timing control circuit to convert a first PWM dimming signal into a second PWM dimming signal according to different image signals. Then, a backlight driving circuit can generate a corresponding backlight driving current according to the second PWM dimming signal. In addition, the backlight driving current generated by the backlight driving circuit according to the second PWM dimming signal with a 100% duty cycle corresponds to maximum value of the backlight driving current of a 3D image signal. Thus, the present invention can not only increase luminance of a display panel when the display panel displays a 3D image, but also maintain normal luminance of the display panel when the display panel displays a 2D image. Therefore, the present invention can not only improve lower luminance of the display panel when the display panel displays the 3D image, but also decrease number of devices and layout windings of the display system and the control circuit to reduce cost and production complexity of the display system and the control circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a control circuit for generating 2D/3D backlight driving currents according to the prior art.

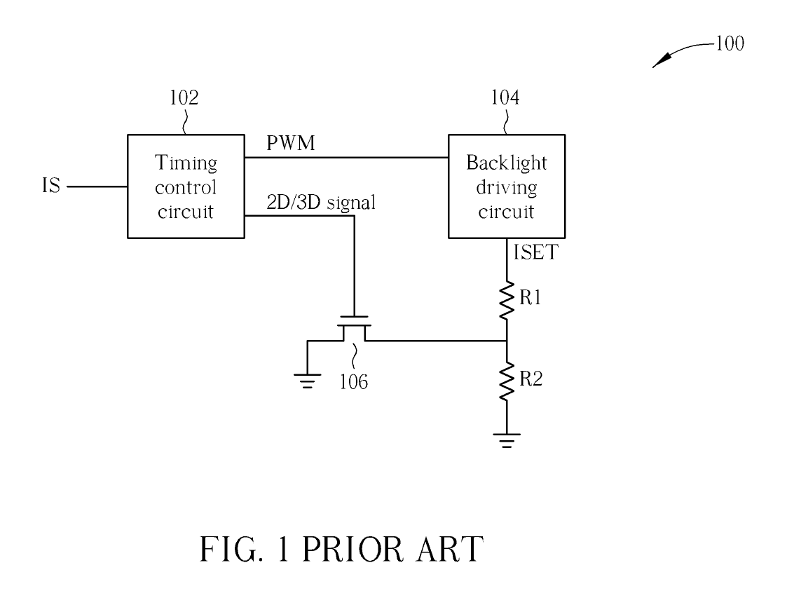

FIG. 2 is a diagram illustrating a control circuit for generating 2D/3D backlight driving currents according to the prior art.

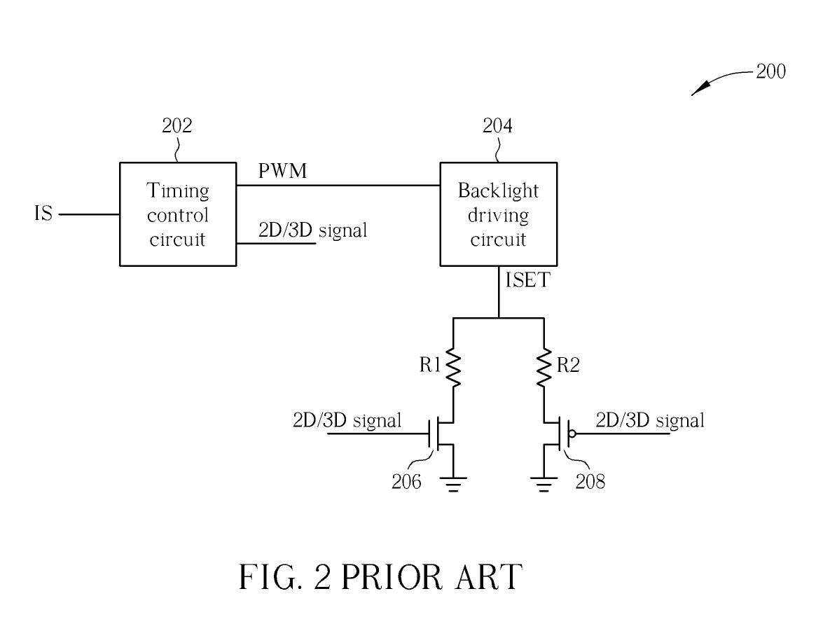

FIG. 3 is a diagram illustrating a control circuit for generating a backlight driving current according to an embodiment.

FIG. 4 is a diagram illustrating the timing control circuit converting a first PWM dimming signal into a second PWM dimming signal according to an image signal.

FIG. 5 is a diagram illustrating the timing control circuit converting a first PWM dimming signal into a second PWM dimming signal according to an image signal.

FIG. 6 is a diagram illustrating the timing control circuit converting a first PWM dimming signal into a second PWM dimming signal and a third PWM dimming signal according to an image signal IS.

FIG. 7 is a flowchart illustrating a method for generating a backlight driving current according to another embodiment.

FIG. 8 is a flowchart illustrating a method for generating a backlight driving current according to another embodiment.

### DETAILED DESCRIPTION

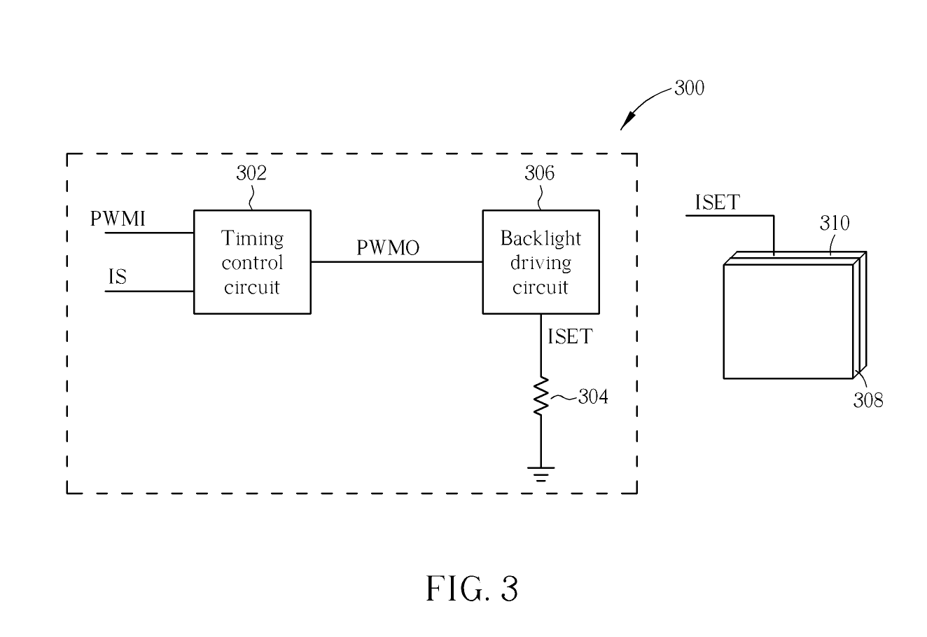

Please refer to FIG. 3. FIG. 3 is a diagram illustrating a control circuit 300 for generating a backlight driving current according to an embodiment. The control circuit 300 includes a timing control circuit 302, a resistor 304, and a backlight driving circuit 306. The timing control circuit 302 is used for receiving a first PWM dimming signal (PWMI) and an image signal (IS), and converting the first PWM dimming signal (PWMI) into a second PWM dimming signal (PWMO) according to the image signal (IS). A duty cycle of the second PWM dimming signal (PWMO) is proportional to a duty cycle of the first PWM dimming signal (PWMI). The backlight driving circuit 306 is coupled to the timing control circuit 302 and the resistor 304 for receiving the second PWM dimming signal (PWMO), and generating a backlight driving current (ISET) according to the second PWM dimming signal (PWMO) and the resistor 304. The backlight driving current (ISET) is used for driving a light emitting diode (LED) backlight module 310 of a display panel 308.

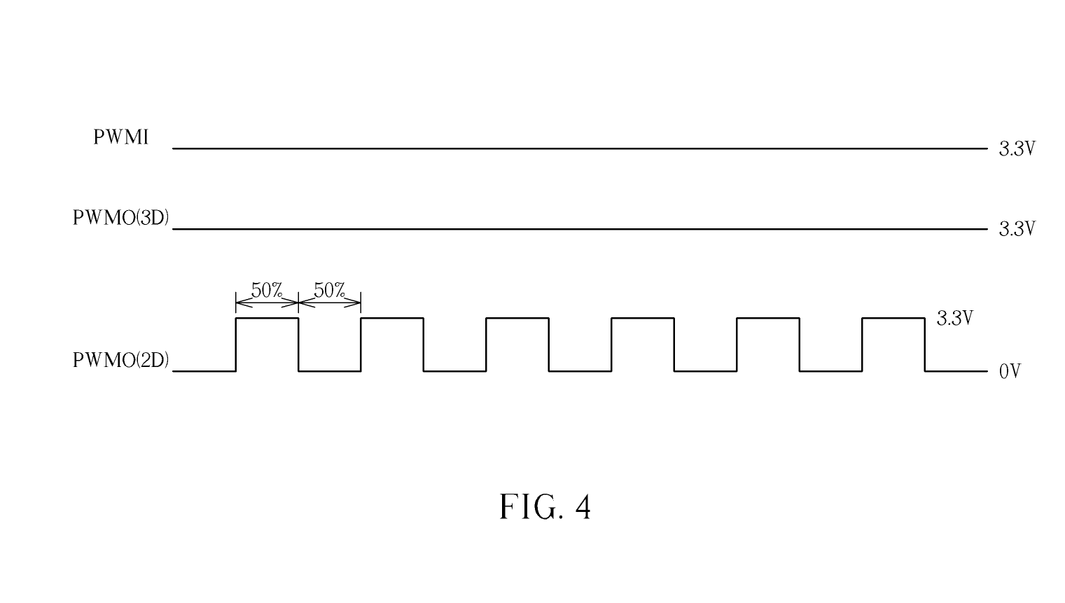

Please refer to FIG. 4. FIG. 4 is a diagram illustrating the timing control circuit 302 converting a first PWM dimming signal PWMI into a second PWM dimming signal PWMO according to an image signal IS. As shown in FIG. 4, taking a maximum value (40 mA) of a three-dimensional (3D) backlight driving current and a maximum value (20 mA) of a two-dimensional (2D) backlight driving current as an example, a default value of a backlight driving current ISET generated by the backlight driving circuit 306 is set to 40 mA. That is to say, the default value of the backlight driving current ISET is the maximum value of the 3D backlight driving current. But, the present invention is not limited to the maximum value of the 3D backlight driving current being 40 mA and the maximum value of the 2D backlight driving current being 20 mA.

When the image signal IS is a 3D image signal, the timing control circuit 302 converts the first PWM dimming signal PWMI into the second PWM dimming signal PWMO according to the image signal IS. As shown in FIG. 4, a duty cycle of the first PWM dimming signal PWMI is 100%, so a duty cycle of the second PWM dimming signal PWMO (3D) is also 100% to maintain the backlight driving current ISET (corresponding to the 3D image signal) at 40 mA. That is to say, when the duty cycle of the second PWM dimming signal PWMO (3D) is 100%, the LED backlight module 310 can generate maximum luminance corresponding to the 3D image signal according to the backlight driving current ISET (40 mA). When the image signal IS is a 2D image signal, the timing control circuit 302 converts the first PWM dimming signal PWMI into the second PWM dimming signal PWMO (2D) according to the image signal IS. As shown in FIG. 4, the duty cycle of the first PWM dimming signal PWMI is 100%, so a duty cycle of the second PWM dimming signal PWMO (2D) is 50% to maintain the backlight driving current ISET (corresponding to the 2D image signal) at 20 mA. That is to say, when the duty cycle of the second PWM dimming signal PWMO (2D) is 50% (corresponding to 100% duty cycle of the 2D image signal), the LED backlight module 310 can generate maximum luminance corresponding to the 2D image signal according to the backlight driving current ISET (20 mA).

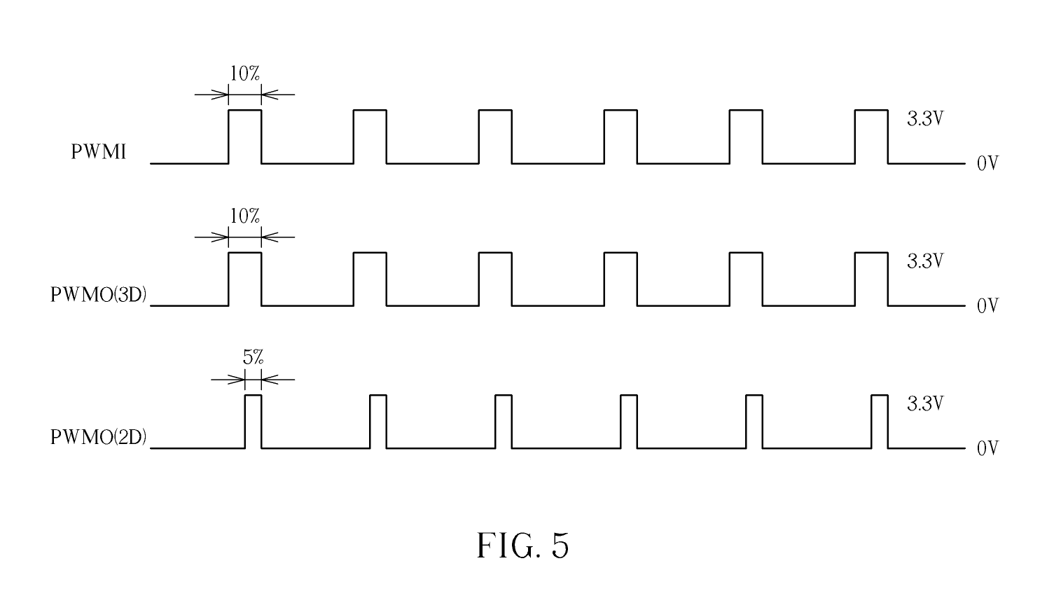

Please refer to FIG. 5. FIG. 5 is a diagram illustrating the timing control circuit 302 converting a first PWM dimming signal PWMI into a second PWM dimming signal PWMO according to an image signal IS. As shown in FIG. 5, when the image signal IS is a 3D image signal, the timing control circuit 302 can also adjust a duty cycle and a frequency of the second PWM dimming signal PWMO (3D) according to requirements of the image signal IS (the 3D image signal). For example, if the image signal IS (the 3D image signal) requires a 4 mA backlight driving current ISET (that is, a duty cycle of the first PWM dimming signal PWMI is 10%), the timing control circuit 302 can adjust the duty cycle of the second PWM dimming signal PWMO (3D) to 10%. Therefore, the backlight driving circuit 306 can generate the backlight driving current ISET (4 mA) corresponding to the image signal IS (the 3D image signal) according to the second PWM dimming signal PWMO (10% duty cycle) and the resistor 304. In addition, because the duty cycle of the first PWM dimming signal PWMI is 10%, the timing control circuit 302 can adjust a duty cycle of the second PWM dimming signal PWMO (2D) to 5% according to the image signal IS (a 2D image signal) when the image signal IS is the 2D image signal. That is to say, the 5% duty cycle of the second PWM dimming signal PWMO (2D) corresponds to a 10% duty cycle of the 2D image signal (50% of 10% is 5%). Therefore, the backlight driving circuit 306 can generate the backlight driving current ISET (2 mA) corresponding to the image signal IS (the 2D image signal) according to the second PWM dimming signal PWMO (2D) (5% duty cycle) and the resistor 304.

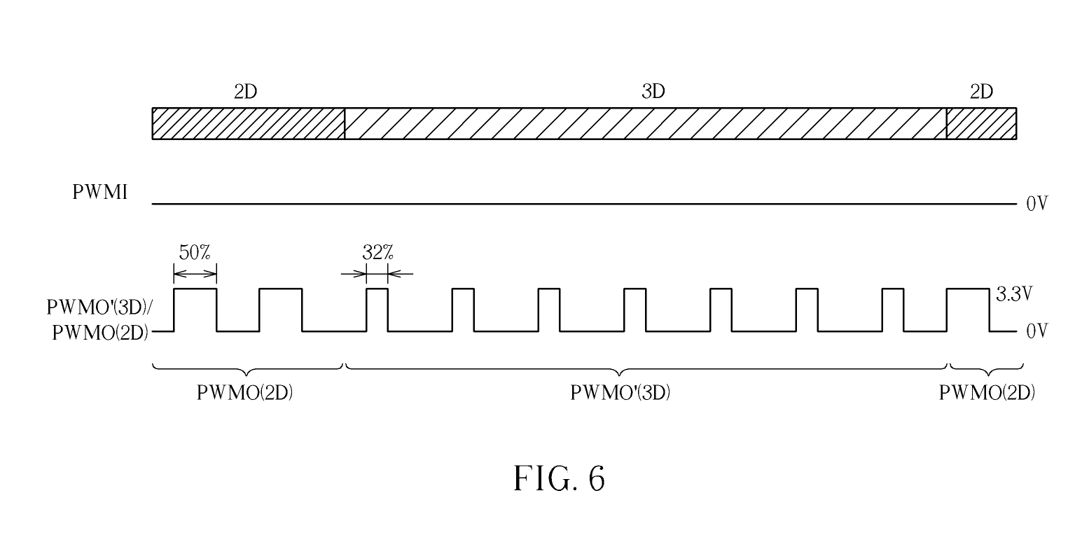

Please refer to FIG. 6. FIG. 6 is a diagram illustrating the timing control circuit 302 converting a first PWM dimming signal PWMI into a second PWM dimming signal PWMO and a third PWM dimming signal PWMO' according to an image signal IS (a 2D image signal and a 3D image signal). As shown in FIG. 6, when the image signal IS is the 2D image signal and a duty cycle of the first PWM dimming signal PWMI corresponding to the 2D image signal is 100%, a duty cycle of the second PWM dimming signal PWMO (2D) corresponding to the 2D image signal is 50% to maintain a backlight driving current ISET (corresponding to the 2D image signal) at 20 mA. When the image signal IS is the 3D image signal, because a turning-on interval of a pair of shutter glasses or a liquid crystal retarder is 32% of the duty cycle of the first PWM dimming signal PWMI, a duty cycle of the third PWM dimming signal PWMO' (3D) corresponding to the 3D image signal is 32%. But, the present invention is not limited to the turning-on interval of the pair of shutter glasses or the liquid crystal retarder being 32% of the duty cycle of the first PWM dimming signal PWMI. Thus, the backlight driving current ISET (corresponding to the 3D image signal) is about 12.8 mA (40 mA*32%).

In addition, in another embodiment of the present invention, the control circuit 300 and the display panel 308 are integrated into a display system. Operational principles of the display system are illustrated in FIG. 3 through FIG. 6, so further description thereof is omitted for simplicity.

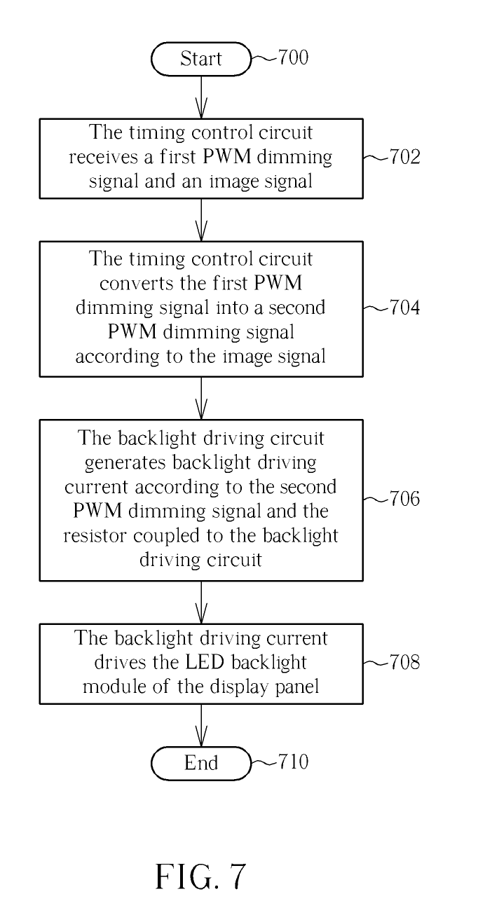

Please refer to FIG. 7. FIG. 7 is a flowchart illustrating a method for generating a backlight driving current according to another embodiment. The method in FIG. 7 is illustrated using the control circuit 300 in FIG. 3. Detailed steps are as follows:

Step 700: Start.

Step 702: The timing control circuit 302 receives a first PWM dimming signal PWMI and an image signal IS.

Step 704: The timing control circuit 302 converts the first PWM dimming signal PWMI into a second PWM dimming signal PWMO according to the image signal IS.

Step 706: The backlight driving circuit 306 generates a backlight driving current ISET according to the second PWM dimming signal PWMO and the resistor 304 coupled to the backlight driving circuit 306.

Step 708: The backlight driving current ISET drives the LED backlight module 310 of the display panel 308.

Step 710: End.

Please refer to FIG. 5. In Step 704, when the image signal IS is a 3D image signal, if the image signal IS (the 3D image signal) requires the 4 mA backlight driving current ISET (that is, a duty cycle of the first PWM dimming signal PWMI is 10%), the timing control circuit 302 can adjust a duty cycle of the second PWM dimming signal PWMO (3D) to 10%. But, the present invention is not limited to the image signal IS (the 3D image signal) requiring the 4 mA backlight driving current ISET. Therefore, in Step 706, the backlight driving circuit 306 can generate the backlight driving current ISET (4 mA) corresponding to the image signal IS (the 3D image signal) according to the second PWM dimming signal PWMO (3D) (10% duty cycle) and the resistor 304. In Step 704, when the image signal IS is a 2D image signal, if the image signal IS (the 2D image signal) requires the 2 mA backlight driving current ISET (that is, the duty cycle of the first PWM dimming signal PWMI is 10%), the timing control circuit 302 can adjust a duty cycle of the second PWM dimming signal PWMO (2D) to 5%. That is to say, the 5% duty cycle of the second PWM dimming signal PWMO corresponds to a 10% duty cycle of the 2D image signal (50% of 10% is 5%). But, the present invention is not limited to the image signal IS (the 2D image signal) requiring the 2 mA backlight driving current ISET. Therefore, in Step 706, the backlight driving circuit 306 can generate the backlight driving current ISET (2 mA) corresponding to the image signal IS (the 2D image signal) according to the second PWM dimming signal PWMO (2D) (5% duty cycle) and the resistor 304.

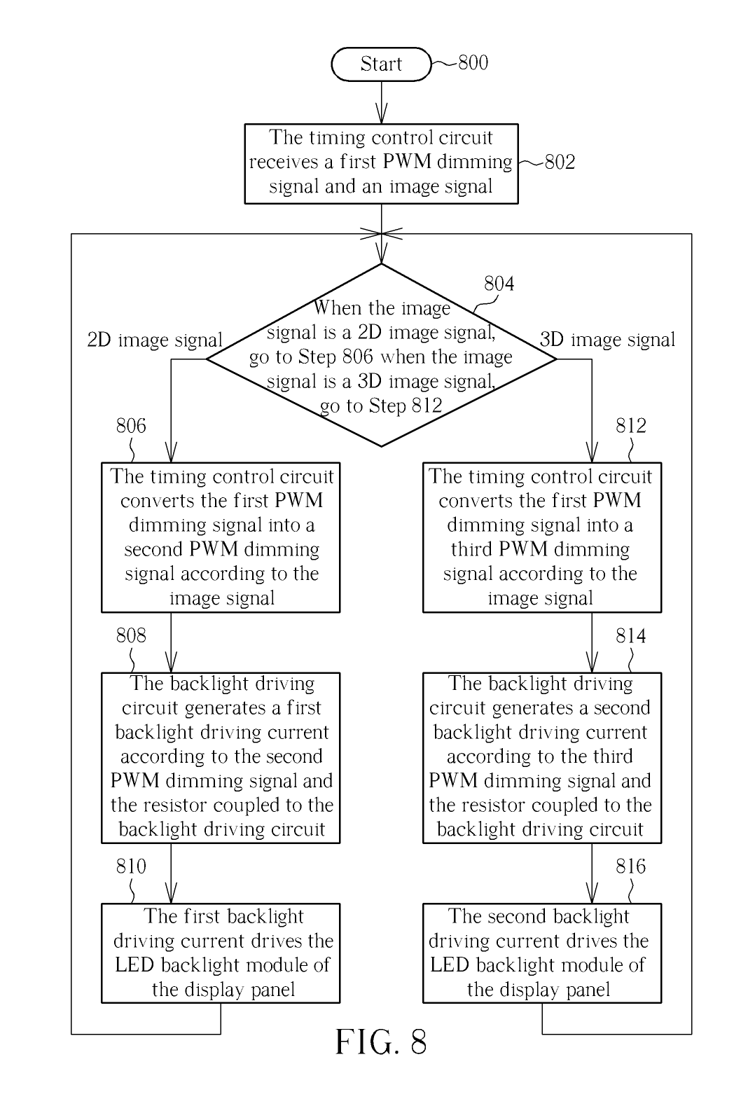

Please refer to FIG. 8. FIG. 8 is a flowchart illustrating a method for generating a backlight driving current according to another embodiment. The method in FIG. 8 is illustrated using the control circuit 300 in FIG. 3. Detailed steps are as follows:

Step 800: Start.

Step 802: The timing control circuit 302 receives a first PWM dimming signal PWMI and an image signal IS.

Step 804: When the image signal IS is a 2D image signal, go to Step 806; when the image signal IS is a 3D image signal, go to Step 812.

Step 806: The timing control circuit 302 converts the first PWM dimming signal PWMI into a second PWM dimming signal PWMO according to the image signal IS.

Step 808: The backlight driving circuit 306 generates a first backlight driving current ISET according to the second PWM dimming signal PWMO and the resistor 304 coupled to the backlight driving circuit 306.

Step 810: The first backlight driving current ISET drives the LED backlight module 310 of the display panel 308; go to Step 804.

Step 812: The timing control circuit 302 converts the first PWM dimming signal PWMI into a third PWM dimming signal PWMO' according to the image signal IS.

Step 814: The backlight driving circuit 306 generates a second backlight driving current ISET' according to the third PWM dimming signal PWMO' and the resistor 304 coupled to the backlight driving circuit 306.

Step 816: The second backlight driving current ISET' drives the LED backlight module 310 of the display panel 308; go to Step 804.

Please refer to FIG. 6. In Step 806, because the image signal IS is the 2D image signal and a duty cycle of the first PWM dimming signal PWMI corresponding to the 2D image signal is 100%, a duty cycle of the second PWM dimming signal PWMO (2D) corresponding to the 2D image signal is 50%. In Step 808, the backlight driving circuit 306 generates a backlight driving current ISET (20 mA) according to the second PWM dimming signal PWMO (2D) (50% duty cycle) and the resistor 304 coupled to the backlight driving circuit 306. In Step 812, because the image signal IS is the 3D image signal and the duty cycle of the first PWM dimming signal PWMI corresponding to the 3D image signal is 100%, a duty cycle of the third PWM dimming signal PWMO' corresponding to the 3D image signal is 32%. That is to say, because a turning-on interval of a pair of shutter glasses or a liquid crystal retarder is 32% of the duty cycle of the first PWM dimming signal PWMI, the duty cycle of the third PWM dimming signal PWMO' (3D) corresponding to the 3D image signal is 32%. In Step 814, the backlight driving circuit 306 generates a backlight driving current ISET (12.2 mA) corresponding to the 3D image signal according to the third PWM dimming signal PWMO' (3D) (32% duty cycle) and the resistor 304 coupled to the backlight driving circuit 306.

To sum up, the display system, the control circuit for generating a backlight driving current and the method thereof utilize the timing control circuit to convert the first PWM dimming signal into the second PWM dimming signal according to different image signals. Then, the backlight driving circuit can generate the corresponding backlight driving current according to the second PWM dimming signal. In addition, the backlight driving current generated by the backlight driving circuit according to the second PWM dimming signal with a 100% duty cycle corresponds to the maximum value of the backlight driving current of the 3D image signal. Thus, the present invention can not only increase luminance of the display panel when the display panel displays 3D images, but also maintain normal luminance of the display panel when the display panel displays 2D images. Therefore, the present invention can not only improve lower luminance of the display panel when the display panel displays the 3D images, but also decrease number of devices and layout winding of the display system and the control circuit.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control circuit for generating a backlight driving current, the control circuit comprising:
a timing control circuit for receiving a first pulse width modulation (PWM) dimming signal and an image signal, and converting the first PWM dimming signal to a second PWM dimming signal according to the image signal, wherein a duty cycle of the second PWM dimming signal is proportional to a duty cycle of the first PWM dimming signal;
a resistor; and
a backlight driving circuit coupled to the timing control circuit and the resistor for receiving the second PWM dimming signal and generating a backlight driving current according to the second PWM dimming signal and the resistor.

2. The control circuit for generating the backlight driving current of claim 1, wherein the image signal is a two-dimensional (2D) image signal or a three-dimensional (3D) image signal.

3. The control circuit for generating the backlight driving current of claim 1, wherein the backlight driving current is used for driving a light emitting diode (LED) backlight module of a display panel.

4. A method for generating a backlight driving current, the method comprising:
receiving a first PWM dimming signal and an image signal;
converting the first PWM dimming signal to a second PWM dimming signal according to the image signal; and
generating a first backlight driving current according to the second PWM dimming signal and a resistor coupled to a backlight driving circuit.

5. The method for generating the backlight driving current of claim 4, further comprising:
the first backlight driving current driving an LED backlight module of a display panel.

6. The method for generating the backlight driving current of claim 4, wherein the image signal is a 2D image signal.

7. The method for generating the backlight driving current of claim 6, wherein converting the first PWM dimming signal to the second PWM dimming signal is converting the first PWM dimming signal to the second PWM dimming signal according to a duty cycle and a frequency of the 2D image signal.

8. The method for generating the backlight driving current of claim 6, further comprising:
receiving a 3D image signal;
converting the first PWM dimming signal to a third PWM dimming signal according to the 3D image signal; and
generating a second backlight driving current according to the third PWM dimming signal and the resistor.

9. The method for generating the backlight driving current of claim 8, further comprising:
the second backlight driving current driving an LED backlight module of a display panel.

10. The method for generating the backlight driving current of claim 8, wherein converting the first PWM dimming signal to the third PWM dimming signal is converting the first PWM dimming signal to the third PWM dimming signal according to a duty cycle and a frequency of the 3D image signal.

11. The method for generating the backlight driving current of claim 4, wherein the image signal is a 3D image signal.

12. The method for generating the backlight driving current of claim 11, wherein converting the first PWM dimming signal to the second PWM dimming signal is converting the first PWM dimming signal to the second PWM dimming signal according to a duty cycle and a frequency of the 3D image signal.

13. A display system comprising:
a display panel;
a timing control circuit for receiving a first PWM dimming signal and an image signal, and converting the first PWM dimming signal to a second PWM dimming signal according to the image signal, wherein a duty cycle of the second PWM dimming signal is proportional to a duty cycle of the first PWM dimming signal;
a resistor; and
a backlight driving circuit coupled to the timing control circuit and the resistor for receiving the second PWM dimming signal and generating a backlight driving current according to the second PWM dimming signal and the resistor;
wherein the backlight driving current is used for driving an LED backlight module of the display panel.
